(19) United States
(12) Patent Application Publication
(10) Pub. No.: US 2024/0162460 A1
(43) Pub. Date: May 16, 2024

(54) PROCESS FOR ACTIVATING A FUEL CELL

(71) Applicants: COMMISSARIAT A L'ENERGIE ATOMIQUE ET AUX ENERGIES ALTERNATIVES, Paris (FR); INSTITUT POLYTECHNIQUE DE GRENOBLE, Grenoble (FR); UNIVERSITE SAVOIE MONT BLANC, Chambery (FR); CNRS, Paris (FR); UNIVERSITE GRENOBLE ALPES, Saint Martin D'heres (FR)

(72) Inventors: Eric PINTON, Grenoble Cedex 09 (FR); Yann BULTEL, Saint Martin d'Heres (FR); Timothée DRUGEOT, Grenoble Cedex 09 (FR); Fabrice MICOUD, Grenoble Cedex 09 (FR)

(73) Assignees: COMMISSARIAT A L'ENERGIE ATOMIQUE ET AUX ENERGIES ALTERNATIVES, Paris (FR); INSTITUT POLYTECHNIQUE DE GRENOBLE, Grenoble (FR); UNIVERSITE SAVOIE MONT BLANC, Chambery (FR); CNRS, Paris (FR); UNIVERSITE GRENOBLE ALPES, Saint Martin D'heres (FR)

(21) Appl. No.: 18/505,367

(22) Filed: Nov. 9, 2023

(30) Foreign Application Priority Data
Nov. 10, 2022 (FR) 22 11720

(51) Int. Cl. H01M 8/04225; H01M 4/86; H01M 4/96; H01M 8/04089; H01M 8/04119; H01M 8/04223; H01M 8/04828; H01M 8/0656; H01M 8/1004

(52) U.S. Cl. CPC H01M 8/04225; H01M 4/8605; H01M 4/96; H01M 8/04097; H01M 8/04126; H01M 8/04231; H01M 8/04268; H01M 8/04835; H01M 8/0656; H01M 8/1004; H01M 2008/1095

(57) ABSTRACT

A method may activate a fuel cell including a plurality of electrochemical cells in a stack, the fuel cell being intended to operate, during at least one nominal operating phase, as an electric generator. Such a method may include, during an activation phase by electrolysis, prior to the at least one nominal operating phase: electrically supplying the fuel cell by an external electric generator, the electric supply being configured to apply an activation voltage greater than the voltage of the cell in an open circuit (OCV); fluid supplying a humid gas fluid at a first electrode and/or a second electrodes. The humid gas may have a relative humidity (RH) such that 40%≤RH<100%. The fuel cell may operate in electrolysis during the activation phase called by electrolysis.

### TECHNICAL FIELD

The present invention relates to the field of fuel cells, in particular proton exchange membrane fuel cells (or PEMFC). It can be implemented to condition or activate a PEMFC, and optimise its performance.

### PRIOR ART

A fuel cell is formed of a stack of “single” electrochemical cells, each comprising an anode and a cathode electrically separated from one another by an electrolyte. In the case of a hydrogen cell, the fuel (hydrogen) is brought into contact with the anode, and the combustion agent (oxygen) is brought into contact with the cathode. During the operation of the current generator cell, the fuel and the combustion agent are consumed by oxidation and reduction reactions which respectively occur at the anode and the cathode. These reactions produce electricity, water and heat. The nominal operating temperature of the cell is generally located around 80° C.

The electrolyte can be presented in the form of a membrane, letting protons coming from the oxidation reaction of the hydrogen pass. It is the case of proton exchange membrane fuel cells (PEMFC). Such a membrane is generally composed of a perfluoro-sulphonated solid polymer called ionomer. The electrodes are typically porous, to favour the transport of fuel and combustion agent gases, and enable the discharge of the water produced. Each electrode typically comprises two layers: a gas diffusion layer, typically carbon-based, and a catalytic layer, generally platinum nanoparticle-based deposited on porous carbon (Pt/C).

The catalytic layers are disposed against the membrane, such that platinum nanoparticles are at the interface with the ionomer. The catalytic layers—also called active layers—are thus inserted between the gas diffusion layers and the membrane. The membrane, the diffusion layers and the catalytic layers are commonly called EMA, meaning “Electrode Membrane Assembly”.

During the implementation of the PEMFC, an initial conditioning phase is generally carried out. This conditioning phase makes it possible for the PEMFC to reach its nominal performance.

This very first operating phase of the PEMFC is generally carried out under favourable conditions in terms of humidity and temperature, in order to correctly hydrate the membrane and “to active” the catalytic layers to progressively increase the initial performance of the cell and reach its nominal performance.

The phenomena occurring during this conditioning phase, also called “activation” or “honing” phase, can comprise both the hydration of the ionomer in the membrane and in the active layers, and/or the depollution of the catalytic layers and of the diffusion layers in their entirety. In any case, the conditioning or activation phase produces an improvement of the performance of the PEMFC and is therefore a prior requirement to the nominal operation of the cell.

The document, “Advances in rapid and effective break-in/conditioning/recovery of automotive PEMFC stacks, Shyam S. Kocha et al., Current Opinion in Electrochemistry, vol. 31, 100843 (2022)” discloses different methods for activating a PEMFC. All these methods are based on a generator operation of the low-voltage cell, with a voltage per cell ≤1V. These numerous methods indicate that there is a need consisting of improving the current activation procedures. The electrochemical performance of the cells, in particular at high current density, can also be improved.

Document JPH06196187A discloses a method for activating a fuel cell involving an electrolysis operation of the cell. Platinum oxides (catalyst) are typically formed during electrolysis. This method does not make it possible to reduce the platinum oxides.

An aim of the present invention is to propose a method for activating a fuel cell improving the electrochemical performance of the cells vis-A-vis known methods and/or overcoming the disadvantages mentioned above.

Other aims, features and advantages of the present invention will appear upon examining the description below and the accompanying drawings. It is understood that other advantages can be incorporated.

### SUMMARY

To achieve this aim, according to an embodiment, a method for activating a fuel cell is provided, comprising a plurality of electrochemical cells in a stack, each cell comprising a first electrode, a second electrode, and a proton exchange membrane inserted between said first and second electrodes, the first electrode comprising a first gas diffusion conductive layer and a first porous carbon-based catalytic layer and in contact with the membrane, the second electrode comprising a second gas diffusion conductive layer and a second porous carbon-based catalytic layer and in contact with the membrane.

The fuel cell is intended to operate, during at least one nominal operating phase, in an electric generator. During this nominal operating phase, the cell is conventionally supplied with reactive gases—the fuel and the combustion agent, typically in hydrogen at the anode (corresponding, for example, to the first electrode) and in oxygen at the cathode (corresponding, for example, to the second electrode), and provides an electric current by consuming reactive gases.

The activation method comprises, during an activation phase prior to the at least one nominal operating phase:
An electric supply of the fuel cell by an external electric generator, said electric supply being configured to apply an activation voltage per cell greater than or equal to 1V,
A humid gas fluid supply at at least one from among the first and second electrodes, said humid gas having a Relative Humidity (RH), such that 40%≤RH <100%.

The fuel cell thus operates in electrolysis during the activation phase. It receives an electric current and water vapour coming from the humid gas, and produces, in particular, hydrogen and oxygen. The first electrode becomes the cathode and the second electrode becomes the anode, opposite to the generator operation.

It has been noted that this method makes it possible to considerably improve the performance of the cell. The mechanisms at the origin of this unexpected performance, explored in the scope of the development of the present invention, are in particular explained below.

The electrolysis operation of the cell, for an activation voltage per cell greater than or equal to 1V, advantageously makes it possible to corrode some of the carbon of the anode, according to a reaction of the type C+2H₂O→CO₂+4H⁺4e⁻. This corrosion generates a modification of the porosity of the anode. This frees up access routes to catalytic sites of the catalytic layer. During the subsequent nominal operating phase, access to the catalytic sites is facilitated for reactive gases.

The emission of O₂ at the anode, at the core of the active layer, could also be a concurrent factor for freeing up certain access routes for reagents to catalytic sites.

The transport of material, which is the major limitation during the operation of the cell in high density current generator, is thus improved. This makes it possible to increase the current density provided by the cell and by the battery during the nominal operating phase.

The activation method according to the invention thus improves the nominal operation of the cell in generator mode, in particular at high current density. The yield is improved for a given nominal power. At the same time, for a given nominal power, it is possible to reduce the number of cells in the stack, which reduces the total cost of the cell.

Preferably, the method further comprises a conditioning step, wherein the fuel cell operates as an electric generator, said conditioning step being carried out before or after the activation phase by electrolysis. This conditioning step is carried out conventionally, for example according to a protocol recommended by the manufacturer of the cell or according to a conditioning method disclosed by the document “Advances in rapid and effective break-in/conditioning/recovery of automotive PEMFC stacks, Shyam S. Kocha et al., Current Opinion in Electrochemistry, vol. 31, 100843 (2022)”. The activation method according to the invention thus typically complements the conventional conditioning method. The additional conditioning duration linked to the activation method according to the invention is preferably less than or equal to 5 minutes, and preferably less than 3 minutes. This makes it possible to obtain a gain in performance for a limited conditioning extra cost.

An unintuitive principle of the invention thus consists of making the cells operate briefly in “electrolysis” mode, i.e. that the cell becomes the receiver of the external electric generator, at a typically imposed cell voltage greater than 1V.

According to a technical bias, such an electrolysis operation is not recommended, as this can generate an irreversible degradation of the Pt/C catalyst of the cathode of the cell (during its generator operation), for example, as mentioned in the document, “Proton Exchange Membrane Fuel Cell Reversal: A Review, Congwei Qin et al., Catalysts, vol. 6, 197 (2016)”.

During the development of the present invention, it has been noted that the application of an electrolysis voltage typically of between 1V and 2V per cell, under humid gas by controlling the Relative Humidity, does not alter the catalytic layers. These are typically oxidised and passivated by one or more of the PtOₓ oxides during the activation phase by electrolysis, but this oxidation state is reversible. As soon as the cell operates again in generator, the PtOₓ oxides are reduced and the catalytic properties are restored, by preserving the benefit of the prior activation phase by electrolysis. In particular, the opening and/or the creation of pores by corrosion of the porous carbon surrounding the Pt nanoparticles, are preserved.

The activation method according to the present invention thus makes it possible to improve accessibility to the “metallic Pt” catalytic sites. The transport of reagents to the catalytic sites is more effective and the performance of the cell are thus improved.

According to another aspect, the invention is based on a piece of equipment comprising a fuel cell, comprising a plurality of electrochemical cells in a stack, each cell comprising a first electrode, a second electrode, and a proton exchange membrane inserted between said first and second electrodes, the first electrode comprising a first gas diffusion conductive layer and a first porous carbon-based catalytic layer and in contact with the membrane, the second electrode comprising a second gas diffusion conductive layer and a second porous carbon-based catalytic layer and in contact with the membrane, the equipment comprising an electric generator and a control/command system, configured to:
Impose on the fuel cell, an activation phase prior to a nominal operating phase of the cell, during which the control/command system controls and commands:
   a humid gas fluid supply at at least one from among the first and second electrodes, said humid gas having a Relative Humidity (RH) such that 40%≤HR<100%,
   an electric supply of the fuel cell by the electric generator, said electric supply being configured to apply an activation voltage per cell greater than 1V,
optionally, before or after the activation phase, carrying out a condition step, wherein the fuel cell operates as an electric generator, during which the control/command system controls and commands:
   a hydrogen fluid supply at the first electrode and an oxygen fluid supply at the second electrode,
   an electric connection between the fuel cell and a charge configured to debit an electric current.

According to another aspect, the invention is based on a use of this equipment to condition or activate a fuel cell, in initial conditioning or complementing an initial conditioning.

### BRIEF DESCRIPTION OF THE FIGURES

The aims, objectives, as well as the features and advantages of the invention will best emerge from the detailed description of embodiments of the latter, which are illustrated by the following accompanying drawings, wherein:

FIG. 1 has a flowchart of necessary (solid lines) and optional (dotted lines) steps of the activation method, according to an embodiment of the present invention.

FIG. 2 schematically presents a cell and its EMA in “electrolysis” operating mode, according to an embodiment of the present invention.

FIG. 3 schematically presents a cell and its EMA in “electric generator” operating mode, according to an embodiment of the present invention.

FIG. 4 presents different bias curves after application of the activation method with different activation durations.

The drawings are given as examples and are not limiting of the invention. They constitute principle schematic representations, intended to facilitate the understanding of the invention, and are not necessarily to the scale of practical applications. In particular, the bipolar electric connection plates are not represented.

### DETAILED DESCRIPTION

Before starting a detailed review of embodiments of the invention, optional features are stated below, which can optionally be used in association or alternatively:

According to an example, the fluid supply is configured to maintain a humidity ratio within the cells, in particular at the membrane of each cell, of between +20% and −20% of a nominal humidity ratio of the membrane. This nominal humidity ratio of the membrane can be provided by the manufacturer. It can be measured by high-frequency resistance measurements. Operationally, the humid gas in particular serves to provide the water necessary for the activation phase by electrolysis—which consumes water—and to hydrate the membrane to favour proton conduction.

According to an example, the method further comprises a conditioning step, wherein the fuel cell operates as an electric generator, said conditioning step being carried out before or after the activation phase by electrolysis. The activation phase by electrolysis and the conditioning step are typically complementary. The activation phase by electrolysis, in particular makes it possible to open the pores of the porous carbon-based electrode, by corrosion of the carbon, to improve access of the reagents to the catalyst particles, in particular to the platinum nanoparticles. The conditioning step typically makes it possible to reduce the platinum oxides to make the catalyst active. The conditioning step also makes it possible to hydrate the ionomer in the membrane and the catalytic layers. The carrying out of a conditioning step and an activation phase by electrolysis makes it possible to significantly increase the performance of the cell.

According to an example, the conditioning step is carried out before the activation phase by electrolysis, and the method further comprises, after the conditioning step and before the activation phase by electrolysis, a step of warming up the cell configured to reach a cell temperature of between 20° C. and 60° C. Controlling the temperature favours controlling the reaction kinetics during electrolysis. The lower the temperature is, the lower the corrosion kinetics of the carbon are. This makes it possible to best control the corrosion kinetics of the carbon during the activation phase.

According to an example, the fluid supply comprises a first supply of a first humid gas at the first electrode and a second supply in a second humid gas at the second electrode, said first and second humid gases each having a Relative Humidity (RH) such that 40% s HR<100%. This makes it possible to improve the input of water in the catalytic and/or hydration layers of the ionomer necessary for the electrolysis reactions. The electrolysis is thus more effective during the activation phase. The duration of the activation phase can, for example, be decreased.

According to an example, the first supply of first humid gas is achieved by recirculation of hydrogen at controlled Relative Humidity. Hydrogen is already the gas used for the other conditioning or operating phases of the cell. The implementation of the activation method is therefore facilitated. According to an example, the second supply of a second humid gas is achieved by injection or recirculation of nitrogen at controlled Relative Humidity. Nitrogen is not reactive. This avoids undesired reactions during the stopping of the electric supply by the external generator, at the end of the activation phase. This also makes it possible to remove the oxygen produced by the electrolysis reaction during the activation phase, and at the end of the activation phase. The electric potential of the electrode (anode in electrolysis, cathode in cell mode) consequently decreases. This typically makes it possible to reduce the platinum oxides formed during the activation phase.

According to an example, the activation phase is carried out at a temperature less than or equal to 60° C., preferably less than or equal to 40° C. The lower the temperature is, the lower the corrosion kinetics of the carbon are. This makes it possible to best control the corrosion kinetics of the carbon during the activation phase.

According to an example, the activation voltage applied to each cell is between 1V and 2V, preferably between 1V and 1.6V. This makes it possible to obtain a significant corrosion reaction of the carbon, without being excessively rapid. The greater the activation voltage is, the greater the corrosion kinetics of the carbon are. A voltage of between 1V and 2V, preferably between 1V and 1.6V, makes it possible to best control the corrosion kinetics of the carbon during the activation phase.

According to an example, the activation voltage applied is constant during the activation phase, without cycling below 1V. A repeated voltage cycling below 1V can generate an atomic rearrangement of the platinum particles (by a reduction/dissolution mechanism) inducing a loss of active surface.

According to an example, the method successively comprises:
a conditioning step, wherein the fuel cell operates as an electric generator, said conditioning step comprising:
   a hydrogen fluid supply at the first electrode and an oxygen fluid supply at the second electrode,
   an electric connection between the fuel cell and a charge configured so as to obtain a first circulation of electrons from the first electrode to the second electrode,
a stopping of the oxygen fluid supply at the second electrode.
a disconnection of the charge,
the activation phase by electrolysis, comprising:
   the supply or a maintaining of the hydrogen fluid supply at the first electrode,
   the humid gas fluid supply at the second electrode, the humid gas being nitrogen,
   the electric supply of the fuel cell by the external electric generator, said electric supply being configured to apply an activation voltage per cell of between 1V and 1.6V, so as to obtain a second circulation of electrons from the second electrode to the first electrode,
a stopping of the electric supply by the external electric generator, after an activation phase duration less than or equal to 300 s,
a stopping of the hydrogen fluid supply at the first electrode,
a removal of the oxygen produced during the activation phase at the second electrode, by maintaining the nitrogen fluid supply, then
a stopping of the nitrogen fluid supply at the second electrode.

According to an example, the method further comprises, after the conditioning step and before the activation phase, a step of cooling or heating the cell, such that the temperature at the cells is between 20° C. and 60° C., preferably between 20° C. and 40° C. The lower the temperature is, the lower the corrosion kinetics of the carbon are. This makes it possible to best control the corrosion kinetics of the carbon during the activation phase.

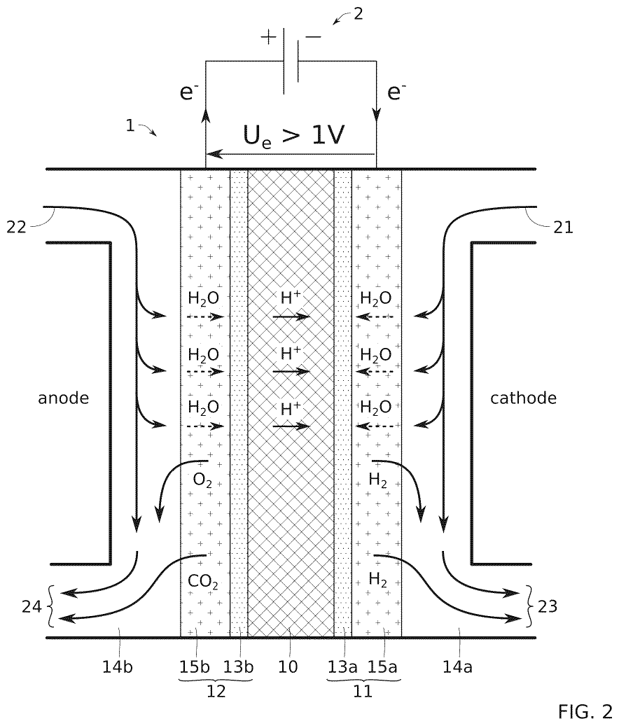

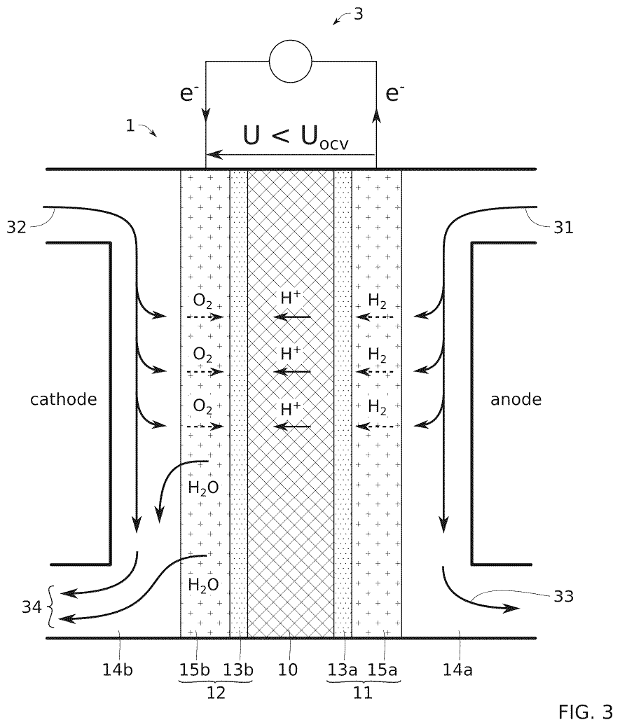

Unless incompatible, technical features described in detail for a given embodiment can be combined with the technical features described in the context of other embodiments described as examples, and in a non-limiting manner. In particular, elements described or illustrated in the figures for the cell or for the method can be combined so as to form another embodiment, which is not necessarily illustrated or described. Such an embodiment is clearly not excluded from the invention. For reasons of clarity, one single cell is illustrated in FIGS. 2 and 3. A fuel cell according to the present invention typically comprises several electrochemical cells in a stack. A person skilled in the art will have no difficulty in implementing an embodiment of the method for one or more electrochemical cells.

In the scope of the present invention, by “fuel cell”, this means a system comprising one or more interconnected electrochemical cells. The cells are typically presented in the form of an Electrode Membrane Assembly commonly called EMA. The activation method is applied, in this case, preferably to a cell sized for industrial applications. Thus, the cell preferably comprises a plurality of electrochemical cells, which typically form a power stack. The cell comprises, in this case, preferably at least five cells in a stack within the EMA, and preferably at least ten.

The cell typically has different operating phases, in particular, one or more initial conditioning phases, one or more nominal production phases, optionally one or more regeneration phases, a stopping phase.

During a nominal operating or production phase of the cell, the cells of the battery are typically supplied with fuel and with combustion agent at nominal concentrations and according to nominal flow rates. The cell debits a current and the power of the cell can be regulated either in voltage, or in current. The cell thus operates as an electric generator.

The activation method according to the present invention more specifically deals with initial conditioning phases, also called activation or honing phases, which occur before the nominal operating phase of the cell.

The initial conditioning phases aim to bring the performance of the cell to a nominal performance level, or at least to 90% of the nominal performance level, according to the desired expected level criterion. According to conventional conditioning or activation methods, the cell operates as an electric generator according to the fluid supply and/or regulation parameters which are not nominal. According to a known example, the cell is regulated by low-voltage voltage, typically at a voltage s 0.5V. According to another known example, the cells can be supplied by a supply fluid having a reduced molar fraction of combustion agent.

The original idea implemented in the scope of the development of the present invention consists, in particular, of carrying out an activation phase by electrolysis, during which the cell consumes electric current and water, and produces, in particular, oxygen, hydrogen and carbon dioxide.

During a phase of regenerating the cell, the cell typically operates as an electric generator, according to the fluid supply and/or regulation parameters, which are not nominal, like for the conditioning. For example, the cells can be supplied by a supply fluid having a reduced molar fraction of combustion agent.

During a stopping phase, the cell is no longer supplied with fuel and/or with combustion agent. The cell can continue to produce an electric current temporarily and degressively.

By “Relative Humidity (RH”), this means the quantity of water vapour present in a gas, expressed as a percentage (% RH) of the quantity necessary to reach a saturation level, at a given temperature and a given pressure. The Relative Humidity thus corresponds to the ratio of the partial pressure of the water vapour contained in the gas over the saturating vapour pressure, for one same temperature. It can typically be measured using a hygrometer. The reference temperature is typically the temperature of the cell, preferably the temperature of the cell.

Several embodiments of the invention implementing successive steps of the activation method are described below. Unless explicitly mentioned, the adjective “successive” does not necessarily imply, even if this is generally preferred, that the steps follow one another immediately, intermediate steps being able to separate them.

Moreover, the term “step” means the carrying out of some of the method, and can mean a set of substeps.

Moreover, the term “step” does not compulsorily mean that the actions carried out during a step are simultaneous or immediately successive. Certain actions of a first step can in particular be followed by actions linked to a different step, and other actions of the first step can then be resumed. Thus, the term “step” does not necessarily mean single and inseparable actions over time and in the sequence of phases of the method.

In the present application, an activation voltage Uₑ is applied by an external generator. The external generator does not form part of the cell. The activation voltage Uₑ corresponds, in this case, to the potential difference between the anode and the cathode of the cell or of the cell in question. This activation voltage can therefore be directly measured on the cell. It is greater than or equal to 1V. The activation voltage Uₑ is also called “electrolysis voltage” or also “cell voltage”, or simply “voltage” below, without ambiguity for a person skilled in the art.

In the present application, in the illustrated figures, the direction of the electric current represented by arrows corresponds to the actual direction of circulation of the electrons. The electron flow thus circulates from the anode to the cathode. This convention is true, both in generator mode and in electrolysis mode.

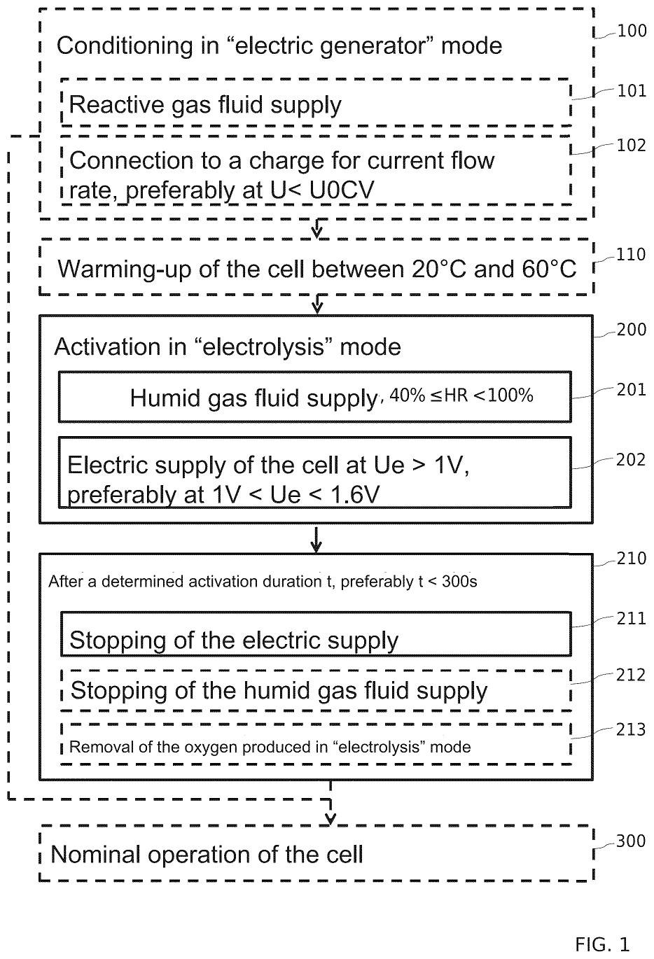

FIG. 1 is a flowchart of the activation method according to an embodiment of the present invention.

The dotted lines indicate optional steps of the activation method. The solid lines indicate the main steps of the activation method.

According to an option, a conditioning 100 or preconditioning of the cell is first carried out. Such a conditioning 100 can be done standardly, according to the operating conditions recommended by the manufacturer. During this conditioning 100, the cell is typically supplied 101 with reactive gases, for example, with air or with oxygen at the cathode and with hydrogen at the anode, and a charge is connected 102 to the electrodes, such that the cell debits an electric current between the anode and the cathode, at a voltage U, preferably less than or equal to 0.8V.

According to an option, the cell is warmed up 110 so as to obtain a cell temperature of between 20° C. and 60° C. This can involve a heating or preheating, typically if the cell has not been subjected to conditioning 100 immediately before the activation phase 200. This can involve a cooling, typically if the cell has been subjected to conditioning 100 immediately before the activation phase 200.

The activation phase by electrolysis 200 of the cell can be carried out individually, or preferably complementarily to the conditioning 100. If the conditioning 100 has been carried out prior to the activation phase 200, the distribution of combustion agent (air or oxygen) is preferably stopped. The charge is preferably disconnected or stopped.

During the activation phase by electrolysis 200, the cell is supplied 201 with humid gases, and connected to an external electric generator configured to make an electric current circulate 202 through the cell at an activation voltage Uₑ greater than the voltage of the cell in an open circuit U_{OCV}.

If the conditioning 100 has been carried out prior to the activation phase 200, the hydrogen distribution can be maintained, for example by recirculation, by controlling the Relative Humidity (RH), such that the hydrogen has a Relative Humidity greater than or equal to 40%. Alternatively, if the conditioning 100 has not been carried out before the activation phase 200, a humid gas of at least 40% RH and strictly less than 100% RH is injected at the electrode which becomes a cathode in electrolysis configuration. This humid gas can be hydrogen, nitrogen or an inert gas, for example.

This humid gas supply, preferably by continuous sweeping, makes it possible to provide the water necessary for the electrolysis reaction and/or for hydrating the membrane of the cell. If the conditioning 100 has been carried out prior to the activation phase 200, the oxygen distribution at the other electrode, which becomes an anode in electrolysis configuration, is preferably stopped and replaced by a humid gas distribution having a Relative Humidity RH such that 40%≤RH<100%, for example, nitrogen. The residual oxygen coming from the conditioning phase 100 is preferably removed, such that the cell voltage U decreases, preferably up to around 0.1V. The removal of oxygen can be done by progressive replacement by nitrogen, or according to another option by consumption of the remaining oxygen by briefly activating the charge.

Before connecting the external generator to the cell to start electrolysis, the temperature of the cell is preferably fixed between 20° C. and 60° C., preferably between 20° C. and 40° C., for example, around 30° C. The kinetics of the reactions occurring during electrolysis is thus decreased. This makes it possible to have a better control of these reactions, in particular vis-A-vis the corrosion of the carbon, which is one of the reactions of interest occurring during electrolysis.

The external generator is then connected, terminal “+” of the generator to the anode in electrolysis configuration, in order to apply 202 an activation voltage Uₑ to the cells, preferably constant and between 1 and 1.6V. An activation voltage Uₑ≤1.6V makes it possible to best control the reaction kinetics.

After an activation duration t to be chosen 210 by the user, according to an economic criterion for example, typically 10 s<t<300 s, the electric supply provided by the external generator is stopped 211. This makes it possible to stop the electrolysis. The activation phase 200 ends. The humid gas fluid supply can be stopped 212.

The oxygen produced at the anode in electrolysis configuration is preferably removed 213 to lower the electrode potential and thus reduce the platinum oxides formed during electrolysis. The removal of the oxygen can be done continuously by the sweeping of humid nitrogen used during electrolysis, or according to another option by consuming the remaining oxygen by connecting and briefly activating the charge until reaching a cell voltage U<0.8V, and preferably U<0.2V, for example, U=0.1V.

Alternatively, if the conditioning 100 has not been carried out before the activation phase 200, the conditioning 100 can be carried out after the activation phase. This also makes it possible to reduce the platinum oxides and to activate the catalyst.

The activation phase 200, with preconditioning or postconditioning 100, advantageously makes it possible to prepare the cell for a nominal operation 300. The nominal performance of the cell is improved, thanks to the activation method.

FIG. 2 illustrates a cell 1 of battery connected to an external electric generator 2 in electrolysis configuration, according to an embodiment of the activation phase according to the invention.

The cell typically comprises a membrane 10, a first catalytic layer 13a, a first gas diffusion layer 15a connected to a first fluid circuit 14a, and a second catalytic layer 13b, a second gas diffusion layer 15b connected to a second fluid circuit 14b. The membrane 10 is preferably with the basis of a perfluoro-sulphonated ionomer, for example NAFION®-based. The first and second diffusion layers 11, 12 are preferably porous carbon-based. The first and second catalytic layers 13a, 13b are preferably with the basis of platinum nanoparticles supported by porous carbon and the ionomer. The first gas diffusion layer 15a and the first catalytic layer 13a form the first electrode 11. The second gas diffusion layer 15b and the second catalytic layer 13b form the second electrode 12.

The first and second electrodes 11, 12 are intended to be electrically connected, either to a charge (cell mode) or to a generator (electrolysis mode). This electrical connection is schematised in FIGS. 2 and 3. In practice, this electric connection is made typically by way of electrically conductive bipolar plates (not illustrated). In a known manner, the bipolar plates are generally in direct electric contact with the gas diffusion layers 15a, 15b. They enable to put the different cells of the stack which form the battery in electric series. Alternatively, the bipolar plates can, in certain cases, be in direct contact with the catalytic layers, being able to thus be considered as gas diffusion layers.

In electrolysis mode, the first electrode 11 corresponds to the cathode and the second electrode 12 corresponds to the anode. The external electric generator 2 is connected by its terminal “+” to the anode and by its terminal “−” to the cathode. The external electric generator 2 thus imposes an electron flow circulating thus from the anode to the cathode. In this example, the cathode is supplied by a first humid gas 21 via the first fluid circuit 14a. This first humid gas 21 can be hydrogen or nitrogen, for example. Other gases can also be considered, for example, inert gases. The water provided by the first humid gas 21 will pass through the first gas diffusion layer 15a, the first catalytic layer 13a, and hydrate the membrane 10.

The anode is supplied by a second humid gas 22 via the second fluid circuit 14b. This second humid gas 22 can be nitrogen or humid air, for example. Other gases can also be considered. The water provided by the second humid gas 22 will pass through the second gas diffusion layer 15b, the second catalytic layer 13b, and hydrate the membrane 10.

The generator 2 is configured to deliver a current through the cell, with an activation voltage Uₑ substantially constant between the electrodes 11, 12. This activation voltage Uₑ is greater than or equal to 1V. In particular, the activation voltage Uₑ is chosen such that 1V <Uₑ<2V, preferably 1V<Uₑ≤1.6V.

Water will be separated under the effect of the electric current and produce hydrogen at the first catalytic layer 13a, oxygen at the second catalytic layer 13b, carbon dioxide in contact with the carbon of the second catalytic layer 13b, and platinum oxides in contact with the platinum of the second catalytic layer 13b according to the following half-reactions:

At the anode:

H₂O→½O₂+2H⁺+2e⁻

C+2H₂O→CO₂+4H⁺+4e⁻

Pt+H₂O→Pt—O+2H⁺+2e⁻

At the cathode:

2H⁺+2e⁻→H₂

The H⁺ protons cross through the proton exchange membrane 10, from the anode to the cathode. Hydrogen 23 can be recovered at the output of the first fluid circuit 14a. Oxygen and carbon dioxide 24 can be discharged at the output of the second fluid circuit 14b.

These reactions occur for Uₑ≥1V and preferably Uₑ≥1.2V. The controlled corrosion of the carbon is one of the aspects of the activation method, which contribute to increasing the performance of the cell during its nominal operation.

FIG. 3 illustrates a cell 1 of a battery, connected to a charge 3, as an electric generator configuration (cell mode). Such a configuration corresponds, in particular, to the nominal operation of the cell. Such a configuration also corresponds to a standard conditioning of the cell before its nominal operation.

In cell mode, the first electrode 11 corresponds to the anode and the second electrode 12 corresponds to the cathode. The two electrodes 11, 12 are connected to a charge 3.

In this example, the anode is supplied by a fuel gas 31, typically hydrogen, via the first fluid circuit 14a. The cathode is supplied by a combustion agent gas 32, typically oxygen or air, via the second fluid circuit 14b. In a known manner, hydrogen and oxygen respectively pass through the first and second gas diffusion layers 15a, 15b and respectively react within the first catalytic layer 13a and the second catalytic layer 13b. Hydrogen and oxygen react to produce water, heat and electric current. Unconsumed hydrogen 33 can be recovered at the output of the first fluid circuit 14a. The combustion agent depleted gas 34 and water can be discharged and/or recovered at the output of the second fluid circuit 14b.

The charge 3 is configured to absorb the electron flow generated by the cell. This electron flow circulates from the anode to the cathode. The voltage U between the electrodes 11, 12, for an initial conditioning phase, is typically less than the voltage of the cell in an open circuit U_{OCV}.

Such an initial conditioning phase, carried out in combination with the activation phase, before or after said activation phase, makes it possible to obtain significant gains in performance during the nominal operation of the cell.

According to an example, after initial conditioning, a low-temperature activation phase, of around 30° C., by maintaining a humidity of around 80% RH, and at an activation voltage Uₑ of between 1.4V and 1.6V, is carried out. This makes it possible to corrode the carbon sufficiently and without excess, while easily controlling the reaction kinetics. The reproducibility of the activation method is thus improved.

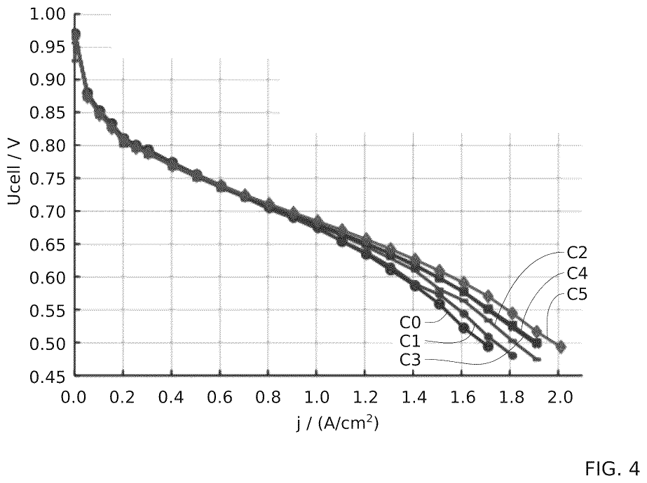

The performance of the cell has been evaluated by performance measurements by bias curves. FIG. 4 presents bias curves obtained after implementation of the activation method, for different durations t of the activation phase by electrolysis: t=30 s (C₁), t=90 s (C₂), t=150 s (C₃), t=210 s (C₄), t=270 s (C₅). The activation phase has been carried out in circulation of hydrogen at the cathode and in circulation of nitrogen at the anode, at 80% RH at 30° C., and for an activation voltage Uₑ=1.6V. The bias curves C₁ . . . C₅ are compared to the bias curve C₀ performed for a cell having been conditioned, only by the initial conditioning phase, without activation phase by electrolysis. At 1.5 A/cm², the maximum gain (curve C₅) is around 50 mV (that is around 9% by voltage). At 0.55V, the maximum gain (curve C₅) is 0.3 A/cm² (that is around 20% by power). The performance of the cell are therefore significantly improved, in particular, at a low voltage U<0.7V and for significant current densities.

Complementary cyclic voltammetry measurements of the catalytic layer 13b under inert gas (not illustrated) also show that the cell undergoes no significant alteration of the platinum electroactive surface after the activation phase by electrolysis according to the activation method. The performance of the cell for a voltage greater than 0.8V are not degraded by this activation phase by electrolysis.

Thus, it clearly appears that the activation method according to the invention is very effective and enables a significant performance gain with respect to the conditioning methods according to the prior art. It can advantageously be implemented in the scope of an initial conditioning of the cell, before any use in nominal operating phase.

The parameters of the activation phase described above can be adjusted and optimised according to the design of the EMA or a performance level to reach for the cell.

Choosing the parameters of the activation phase can be validated by performance measurements, for example, by comparing bias curves before and after implementation of the activation method.

These measurements can be completed by an evaluation of the development of the diffusion or bias resistance, by impedance spectroscopy (resistance to be minimised).

These measurements can be completed by performance measurements at one or more specific operating points, for example, at the power or at the nominal, and maximum current density.

These measures can be completed by an evaluation of the development of the platinum electroactive surface by cyclic voltammetry (losses to be minimised).

The invention is not limited to the embodiments described above. All the activation options, with or without initial conditioning, for a cell comprising one or more cells, with recirculation or injection of humid gas, can be considered.

1. A method for activating a fuel cell,
the method comprising, during an activation phase prior to at least one nominal operating phase;
electrically supplying the fuel cell by an external electric generator with an electric supply configured to apply an activation voltage per cell greater than or equal to 1V;
fluid supplying a humid gas at a first electrode and/or second electrode, the humid gas having a relative humidity (RH) such that 40%≤RH<100%,
wherein the fuel cell operates in electrolysis during the activation phase called electrolysis,
wherein the fluid supplying comprises a first supply of a first humid gas at the first electrode and a second supply of a second humid gas at the second electrode,
wherein first and second humid gases each have a relative humidity (RH) such that 40%≤RH<100%,
wherein the first supply of the first humid gas comprises recirculating hydrogen at controlled relative humidity and the second supply of the second humid gas comprises injecting or recirculating nitrogen at controlled relative humidity,
wherein the fuel cell comprises a plurality of electrochemical cells in a stack, each cell comprising the first electrode, the second electrode, and a proton exchange membrane inserted between the first and second electrodes,
wherein the first electrode comprises a first gas diffusion conductive layer and a first porous carbon-based catalytic layer and contacts with the membrane,
wherein the second electrode comprises a second gas diffusion conductive layer and a second porous carbon-based catalytic layer and in contact with the membrane, and
wherein the fuel cell configured to operate, during the at least one nominal operating phase, as an electric generator.

2. The method of claim 1, further comprising:
operating the fuel cell as an electric generator as a conditioning, the conditioning being carried out before or after the activation phase by electrolysis.

3. The method of claim 2, wherein the conditioning is carried out before the activation phase by electrolysis, and
wherein method further comprising, after the conditioning and before the activation phase by electrolysis;
warming up the cell configured to reach a cell temperature in a range of from 20 to 60° C.

4. The method of claim 1, wherein the activation phase is carried out at a temperature less than or equal to 60° C.

5. The method of claim 1, wherein an activation voltage applied to each cell is in a range of from 1 to 2V.

6. The method of claim 1, wherein and applied activation voltage is constant during the activation phase, without cycling of below 1V.

7. The method of claim 1, successively comprising:
a conditioning comprising the fuel cell operating as an electric generator,
providing a hydrogen fluid supply at the first electrode and an oxygen fluid supply at the second electrode, and
electrically connecting with an electric connection between the fuel cell and a charge, so as to obtain a first circulation of electrons from the first electrode to the second electrode;
stopping the oxygen fluid supply at the second electrode;
disconnecting the charge;
conducting the activation phase by electrolysis, comprising
the fluid supplying or a maintaining of the hydrogen fluid supply at the first electrode, (ii)
the fluid supplying of the humid gas at the second electrode, the humid gas being nitrogen, and (iii) the electrically supplying
of the fuel cell by the external electric generator, the electric supply being configured to apply an activation voltage in a range of from 1 to 1.6V, so as to obtain a second circulation of electrons from the second electrode to the first electrode;
first stopping the electric supply by the external electric generator after a duration t of the activation phase less than or equal to 300 s;
a second stopping the hydrogen fluid supply at the first electrode;
removing the oxygen produced during the activation phase at the second electrode, while maintaining the nitrogen fluid supply; then
third stopping the nitrogen fluid supply at the second electrode.

8. The method of claim 7, further comprising, after the conditioning and before the activation phase:
warming-up, such that a temperature at the cells is in a range of from 20 to 60° C.

9. Equipment, comprising:
a fuel cell comprising a plurality of electrochemical cells in a stack, each cell comprising a first electrode, a second electrode, and a proton exchange membrane inserted between the first and second electrodes, the first electrode comprising a first gas diffusion conductive layer and a first porous carbon-based catalytic layer and in contact with the membrane, the second electrode comprising a second gas diffusion conductive layer and a second porous carbon-based catalytic layer (13b) and in contact with the membrane, the equipment comprising an electric generator and a control/command system configured to:
impose an activation phase on the fuel cell, prior to a nominal operating phase of the cell, during which the control/command system controls and commands:
a hydrogen fluid supply (201) at the first electrode (11) and a nitrogen fluid supply at the second electrode (12), the hydrogen and nitrogen having a relative humidity (RH) such that 40%≤RH<100%,
an electric supply of the fuel cell by the electric generator the electric supply being configured to apply an activation voltage per cell greater than or equal to 1V.

10. The equipment of claim 9, wherein the control/command system is configured to:
before or after the activation phase, carry out a conditioning wherein the fuel cell operates as an electric generator, during which the control/command system controls and commands:
a hydrogen fluid supply at the first electrode and an oxygen fluid supply at the second electrode;
an electric connection of the first and second electrodes with a chare configured to debit an electric current between the first and second electrodes.

11. The equipment of claim 10, wherein the conditioning is carried out before the activation phase by electrolysis, and wherein the control/command system is configured to carry out, after the conditioning, and before the activation phase by electrolysis, warming up the cell to reach a cell temperature in a range of from 20 to 60° C.

12. A method of conditioning or activating a fuel cell, the method comprising:
operating the equipment of claim 9.

13. The method of claim 1, wherein the activation phase is carried out at a temperature less than or equal to 40° C.

14. The method of claim 1, wherein an activation voltage applied to each cell is in a range of from 1 to 1.6V.

15. The method of claim 7, further comprising, after the conditioning and before the activation phase:
warming-up, such that a temperature at the cells is in a range of from 20 to 40° C.
